(19) United States
(12) Patent Application Publication
(10) Pub. No.: US 2024/0297335 A1
(43) Pub. Date: Sep. 5, 2024

(54) RECHARGEABLE LITHIUM BATTERY

(71) Applicant: SAMSUNG SDI CO., LTD., Yongin-si (KR)

(72) Inventors: Myunghoon KIM, Yongin-si (KR); Yunhee KIM, Yongin-si (KR); Injun PARK, Yongin-si (KR); Aeran KIM, Yongin-si (KR); Seungryong OH, Yongin-si (KR); Jeongmin SHIN, Yongin-si (KR)

(21) Appl. No.: 18/467,566

(22) Filed: Sep. 14, 2023

(30) Foreign Application Priority Data
Feb. 24, 2023 (KR) 10-2023-0025397

(51) Int. Cl. H01M 10/052; H01M 4/525; H01M 10/0567; H01M 10/0568; H01M 10/44

(52) U.S. Cl. CPC H01M 10/052; H01M 4/525; H01M 10/0567; H01M 10/0568; H01M 10/44; H01M 2004/028

(57) ABSTRACT

A rechargeable lithium battery may include a positive electrode including a positive electrode active material; a negative electrode including a negative electrode active material; and an electrolyte solution including a non-aqueous organic solvent, a lithium salt, and an additive. The positive electrode active material includes a composite oxide having a nickel content (e.g., amount) of greater than about 80 mol % based on a total amount of metals except lithium included in the composite. In addition, the lithium salt includes a compound represented by Chemical Formula 1; the additive includes a compound represented by Chemical Formula 2, and the compound represented by Chemical Formula 1 is included in about 10 wt % to about 80 wt % based on a total amount of the lithium salt.

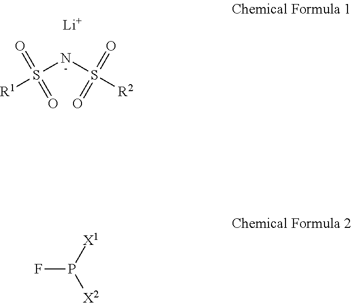

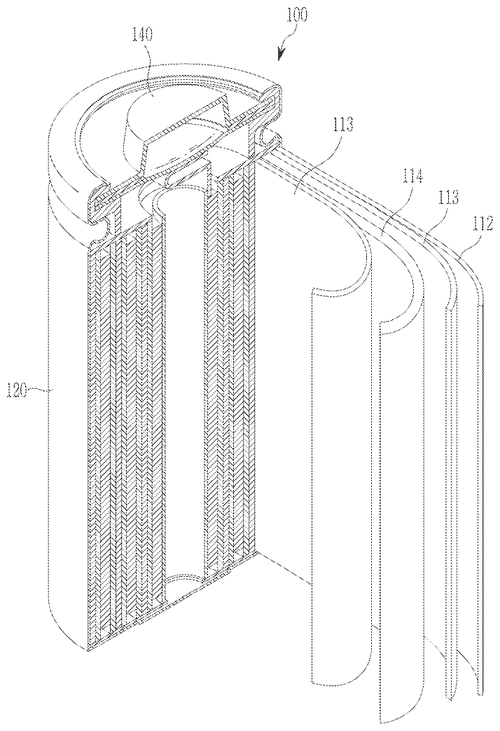

### CROSS-REFERENCE TO RELATED APPLICATION

This application claims priority to and the benefit of Korean Patent Application No. 10-2023-0025397, filed on Feb. 24, 2023, in the Korean Intellectual Property Office, the content of which in its entirety is herein incorporated by reference.

### BACKGROUND OF THE INVENTION

### 1. Field

One or more embodiments of the present disclosure relate to a rechargeable lithium battery.

### 2. Description of Related Art

A rechargeable lithium battery may be recharged and has three or more times higher energy density per unit weight than a comparable lead storage battery, nickel-cadmium battery, nickel hydrogen battery, nickel zinc battery, and/or the like, and may be highly charged and thus, is commercially manufactured for a laptop, a cell phone, an electric tool, an electric bike, and/or the like. Research on improvement of additional energy density of the rechargeable lithium battery has been actively made and/or pursued.

Such a rechargeable lithium battery is manufactured by injecting an electrolyte solution into a battery cell, which includes a positive electrode including a positive electrode active material capable of intercalating/deintercalating lithium ions and a negative electrode including a negative electrode active material capable of intercalating/deintercalating lithium ions.

Recently, development of rechargeable lithium batteries has been progressing in a direction of increasing energy density. However, as the energy density of rechargeable lithium batteries is increased, there are problems and/or issues of deteriorating cycle-life characteristics at room temperature and storage performance at a high temperature and increasing resistance at room temperature and/or at high temperature.

Therefore, it is desirable to combine (1) an electrolyte solution exhibiting improved safety without deteriorating performance at room temperature and/or at high temperature with (2) a positive electrode active material capable of increasing the energy density of a rechargeable lithium battery.

### SUMMARY OF THE INVENTION

One or more aspects of embodiments of the present disclosure are directed to increase the energy density of a rechargeable lithium battery while improving safety at room temperature and/or high temperature without deterioration in performance. Additional possible aspects may be set forth in part in the description which follows and, in part, should be apparent from the description, or may be learned by practice of the presented embodiments of the disclosure.

According to one or more embodiments of the present disclosure, a rechargeable lithium battery includes:
a positive electrode including a positive electrode active material;
a negative electrode including a negative electrode active material; and
an electrolyte solution including a non-aqueous organic solvent, a lithium salt, and an additive,
wherein the positive electrode active material includes a composite oxide having a nickel content (e.g., amount) of greater than about 80 mol % based on a total amount (e.g., total mole amount) of metals except lithium included in the composite oxide,
the lithium salt includes a compound represented by Chemical Formula 1, and the compound represented by Chemical Formula 1 is in about 10 wt % to about 50 wt % based on a total amount of the lithium salt, and
the additive includes a compound represented by Chemical Formula 2:

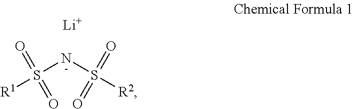

wherein, in Chemical Formula 1,
R¹ and R² may each independently be a fluoro group or a C1 to C4 alkyl

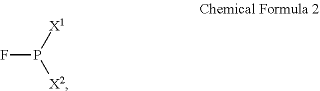

wherein, in Chemical Formula 2,
X¹ and X² may each be a halogen or —O-L¹-R³, provided that at least one of X¹ or X² is —O-L¹-R³;
L¹ may be a single bond or a substituted or unsubstituted C1 to C10 alkylene group;
R³ is each independently a cyano group (—CN), a difluorophosphite group (—OPF₂), a substituted or unsubstituted C1 to C10 alkyl group, a substituted or unsubstituted C2 to C10 alkenyl group, a substituted or unsubstituted C3 to C10 cycloalkyl group, a substituted or unsubstituted C3 to C10 cycloalkenyl group, a substituted or unsubstituted C2 to C10 alkynyl group, a substituted or unsubstituted C3 to C10 cycloalkynyl group, or a substituted or unsubstituted C6 to C20 aryl group; and
if (e.g., when) X¹ and X² are concurrently (e.g., simultaneously) —O-L¹-R³, R³ may each independently be present, or two R³s may be linked to form a substituted or unsubstituted monocyclic or polycyclic aliphatic heterocycle or a substituted or unsubstituted monocyclic or polycyclic aromatic heterocycle.

In Chemical Formula 1, in some embodiments, R¹ and R² may each independently be a fluoro group or a C1 to C4 alkyl group substituted with at least three fluoro groups.

In Chemical Formula 1, in some embodiments, R¹ and R² may be the same.

In one or more embodiments, Chemical Formula 1 may be Chemical Formula 1-1 or 1-2:

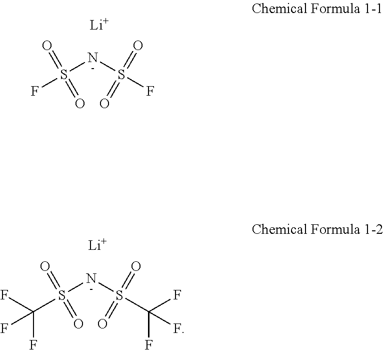 [SMILES: [Li+] ; O=S(=O)(F)NS(=O)(=O)F ; [Li+] ; O=S(=O)(NS(=O)(=O)C(F)(F)F)C(F)(F)F]

The lithium salt may further include one or two or more selected from LiPF₆, LiBF₄, lithium difluoro(oxalate)borate (LiDFOB), LiPO₂F₂, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiN(CₚF₂ₚ₊₁SO₂)(C_{q}F_{2q+1}SO₂), wherein, p and q are integers from 1 to 20, LiCl, LiI, and LiB(C₂O₄)₂ (lithium bis(oxalato) borate: LiBOB).

In one or more embodiments, the lithium salt may include the compound represented by Chemical Formula 1 and LiPF₆.

Based on a total amount of the lithium salt, the compound represented by Chemical Formula 1 may be included in an amount of about 10 wt % to about 50 wt %, and LiPF₆ may be included in a balance amount.

In one or more embodiments, a total amount of the lithium salt may correspond to a molar concentration of about 0.1 M to about 2.0 M in the electrolyte solution.

In Chemical Formula 2, in some embodiments,
one of X¹ and X² may be a fluoro group and the other may be —O-L²-R⁴;
L² may be a single bond or a substituted or unsubstituted C1 to C10 alkylene group; and
R⁴ may be a cyano group (—CN) or a difluorophosphite group (—OPF₂).

In some embodiments, Chemical Formula 2 may be Chemical Formula 2-1:

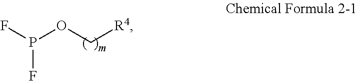

wherein, in Chemical Formula 2-1,
m may be an integer from 1 to 5; and
R⁴ may be a cyano group (—CN) or a difluorophosphite group (—OPF₂).

In some embodiments, in Chemical Formula 2,
X¹ may be —O-L³-R⁵ and X² may be —O-L⁴-R⁶;
L³ and L⁴ may each independently be a single bond or a substituted or unsubstituted C1 to C10 alkylene group; and
R⁵ and R⁶ may each independently be a substituted or unsubstituted C1 to C10 alkyl group, and/or R⁵ and R⁶ may be linked to form a substituted or unsubstituted monocyclic or polycyclic aliphatic heterocycle.

In one or more embodiments, Chemical Formula 2 may be Chemical Formula 2-2:

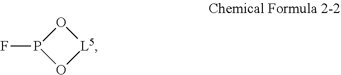

wherein, in Chemical Formula 2-2,
L⁵ may be a substituted or unsubstituted C2 to C5 alkylene group.

In some embodiments, Chemical Formula 2-2 may be Chemical Formula 2-2a or 2-2b:

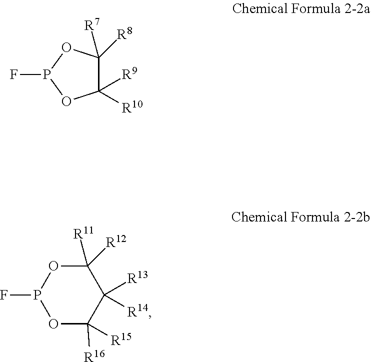

wherein, in Chemical Formulas 2-2a and 2-2b,
R⁷ to R¹⁶ may each independently be hydrogen, a halogen, or a substituted or unsubstituted C1 to C5 alkyl group.

For example, in one or more embodiments, the additive may be any one selected from:

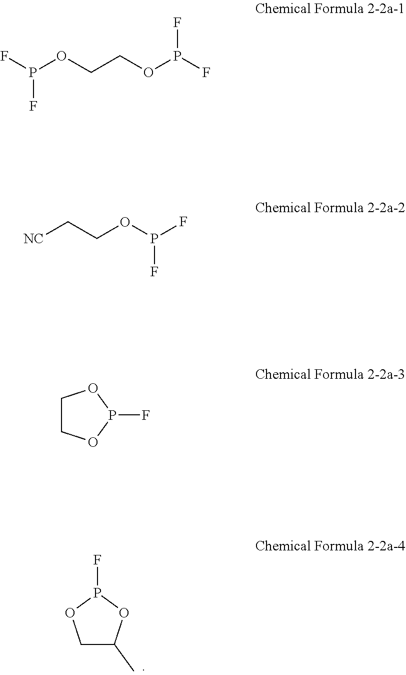

The additive may be included in an amount of about 0.05 wt % to about 5.0 wt % based on a total weight of the electrolyte solution.

In one or more embodiments, the positive electrode active material may include a composite oxide represented by Chemical Formula 3:

LiₐNiₓM¹_{y}M²_{z}O_{2-b}X_{b}, Chemical Formula 3
wherein, in Chemical Formula 3,
0.9≤a<1.2, 0.8<x≤1, 0≤y≤0.2, 0<z≤0.2, x+y+z=1, and 0≤b≤0.1;
M¹ and M² may each independently be one or more elements selected from manganese (Mn), aluminum (Al), boron (B), barium (Ba), calcium (Ca), cerium (Ce), cobalt (Co), chromium (Cr), copper (Cu), iron (Fe), magnesium (Mg), molybdenum (Mo), niobium (Nb), silicon (Si), strontium (Sr), titanium (Ti), vanadium (V), tungsten (W), and zirconium (Zr); and
X may be one or more elements selected from fluorine (F), phosphorus (P), and sulfur (S).

In one or more embodiments, the positive electrode active material may include a composite oxide represented by Chemical Formula 3-1, a composite oxide represented by Chemical Formula 3-2, or a combination thereof:

Liₐ₁Niₓ₁Mn_{y1}M²_{z1}O_{2-b1}X_{b1} Chemical Formula 3-1

Liₐ₂Niₓ₂Mn_{y2}M²_{z2}O_{2-b2}X_{b2} Chemical Formula 3-2
wherein, in Chemical Formulas 3-1 and 3-2,
0.9≤a1<1.2, 0.8<x1≤1, 0≤y1≤0.2, 0<z1≤0.2, x1+y1+z1=1, and 0≤b1≤0.1;
0.9≤a2<1.2, 0.8<x2≤1, 0≤y2≤0.2, 0<z2≤0.2, x2+y2+z2=1, and 0≤b2≤0.1;
M² may be one or more elements selected from B, Ba, Ca, Ce, Co, Cr, Cu, Fe, Mg, Mn, Mo, Nb, Si, Sr, Ti, V, W, and Zr; and
X may be one or more elements selected from F, P, and S.

According to one or more embodiments of the present disclosure, while increasing the energy density of the rechargeable lithium battery, it may also improve safety at room temperature and/or high temperature without deterioration in performance.

### BRIEF DESCRIPTION OF THE DRAWINGS

The accompanying drawing is included to provide a further understanding of the present disclosure, and is incorporated in and constitutes a part of this specification. The drawing illustrates example embodiments of the present disclosure and, together with the description, serve to explain principles of present disclosure. In the drawing:

The drawing is a schematic view showing a rechargeable lithium battery according to one or more embodiments of the present disclosure.

### DETAILED DESCRIPTION

The present disclosure may be modified in many alternate forms, and thus specific embodiments will be exemplified in the drawing and described in more detail. It should be understood, however, that it is not intended to limit the present disclosure to the particular forms disclosed, but rather, is intended to cover all modifications, equivalents, and alternatives falling within the spirit and scope of the present disclosure.

Hereinafter, a rechargeable lithium battery according to one or more embodiments of the present disclosure will be described in more detail with reference to the accompanying drawings. However, these embodiments are example, the present disclosure is not limited thereto and is defined by the scope of claims.

As utilized herein, when a definition is not otherwise provided, “substituted” refers to a replacement of at least one hydrogen of a substituent or a compound by deuterium, a halogen, a hydroxyl group, an amino group, a substituted or unsubstituted C1 to C30 amine group, a nitro group, a substituted or unsubstituted C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C20 alkoxy group, a C1 to C10 alkyl group, a cyano group, or a combination thereof.

In one or more embodiments of the present disclosure, “substituted” refers to replacement of at least one hydrogen of a substituent or a compound by deuterium, a halogen, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 alkyl group, or a cyano group. In some embodiments, “substituted” refers to replacement of at least one hydrogen of a substituent or a compound by deuterium, a halogen, a C1 to C20 alkyl group, a C6 to C30 aryl group, a C1 to C10 alkyl group, or a cyano group. In some embodiments, “substituted” refers to replacement of at least one hydrogen of a substituent or a compound by deuterium, a halogen, a C1 to C5 alkyl group, a C6 to C18 aryl group, a C1 to C5 alkyl group, or a cyano group. In some embodiments, “substituted” refers to replacement of at least one hydrogen of a substituent or a compound by deuterium, a cyano group, a halogen, a methyl group, an ethyl group, a propyl group, a butyl group, a phenyl group, a biphenyl group, a terphenyl group, a trifluoromethyl group, or a naphthyl group.

A lithium rechargeable battery may be classified into a lithium ion battery, a lithium ion polymer battery, or a lithium polymer battery depending on kinds of a separator and an electrolyte solution utilized. It also may be classified to be cylindrical, prismatic, coin-type or kind, pouch-type or kind, and/or the like depending on shape thereof. In some embodiments, it may be bulk type or kind or thin film type or kind depending on sizes thereof. Structures and manufacturing methods for lithium ion batteries pertaining to this disclosure are well suitable in the art.

Herein, as an example of the rechargeable lithium battery, a cylindrical rechargeable lithium battery will be exemplarily described. The drawing schematically illustrates the structure of a rechargeable lithium battery according to one or more embodiments. Referring to the drawing, a rechargeable lithium battery 100 according to one or more embodiments may include a battery cell including a positive electrode 114, a negative electrode 112 facing the positive electrode 114, a separator 113 between the positive electrode 114 and the negative electrode 112, and an electrolyte solution impregnating the positive electrode 114, the negative electrode 112, and the separator 113, a battery case 120 housing the battery cell, and a sealing member 140 sealing the battery case 120.

Hereinafter, a more detailed configuration of the rechargeable lithium battery 100 according to one or more embodiments of the present disclosure will be described.

A rechargeable lithium battery according to one or more embodiments of the present disclosure may include a positive electrode including a positive electrode active material; a negative electrode including a negative electrode active material; and an electrolyte solution including a non-aqueous organic solvent, a lithium salt, and an additive.

(1) In one or more embodiments, the positive electrode active material may be a high-nickel-based positive electrode active material, and includes a composite oxide in which a content (e.g., amount) of nickel is greater than about 80 mol %, greater than or equal to about 85 mol %, or greater than or equal to about 88 mol % of composite oxides, based on a total amount (e.g., total mole amount) of metals (e.g., including transition metals) except lithium included in the composite oxide. The upper limit of the nickel content (e.g., amount) is not particularly limited, but may be less than or equal to about 99 mol %, less than or equal to about 95 mol %, or less than or equal to about 94 mol %.

If (e.g., when) a high-nickel-based positive electrode active material having the same nickel content (e.g., amount) as the aforementioned ranges is applied, by utilizing an electrolyte solution in which a lithium salt including about 10 to about 50 wt % of a compound represented by Chemical Formula 1 (hereinafter referred to as “first lithium salt” in some embodiments) and a compound represented by Chemical Formula 2 (hereinafter referred to as “additive” in some embodiments) are combined, safety of the rechargeable lithium battery may be improved by utilizing the electrolyte solution.

(2) in one or more embodiments, the lithium salt may include a compound represented by Chemical Formula 1, as a first lithium salt, wherein the compound represented by Chemical Formula 1 may be included in an amount of about 10 to about 50 wt % based on a total amount of the lithium salt:

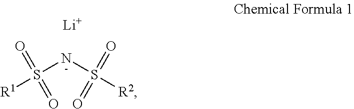

wherein, in Chemical Formula 1,
R¹ and R² may each independently be a fluoro group or a C1 to C4 alkyl group substituted with at least one fluoro group.

The first lithium salt is a compound including a lithium sulfonylimide salt. In the electrolyte solution, if (e.g., when) the first lithium salt decomposes, a film may be formed on surfaces of the positive and negative electrodes. By effectively controlling the elution of lithium ions generated from the positive electrode, a phenomenon of positive electrode decomposition may be suppressed or reduced.

For example, in one or more embodiments, the first lithium salt is reduced and decomposed before decomposition of a carbonate-based solvent included in the non-aqueous organic solvent and forms a SEI (solid electrolyte interface) film on the negative electrode. Accordingly, the decomposition of the electrolyte solution and the resulting decomposition reaction of the electrode may be prevented or reduced, resulting in suppressing an increase in internal resistance due to gas generation.

The SEI film formed on the negative electrode may be partially decomposed through the reduction reaction during the charging and discharging. Components of the SEI films decomposed on the negative electrode may move onto the surface of the positive electrode.

The SEI film components moved onto the surface of the positive electrode also may form a film on the surface of the positive electrode through an oxidation reaction to prevent or reduce decomposition of the surface of the positive electrode and the oxidation reaction of the electrolyte solution. Resultantly, the negative electrode SEI film and the positive electrode SEI film may contribute to improving high-temperature and low-temperature cycle-life characteristics of the rechargeable lithium battery.

(3) In one or more embodiments, the additive may include a compound represented by Chemical Formula 2:

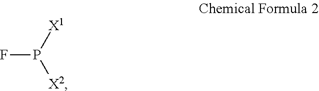

wherein, in Chemical Formula 2,
X¹ and X² may each be a halogen, or —O-L¹-R³, provided that at least one of X¹ or X² may be —O-L¹-R³;
L¹ may be a single bond or a substituted or unsubstituted C1 to C10 alkylene group;
R³ may each independently be a cyano group (—CN), a difluorophosphite group (—OPF₂), a substituted or unsubstituted C1 to C10 alkyl group, a substituted or unsubstituted C2 to C10 alkenyl group, a substituted or unsubstituted C3 to C10 cycloalkyl group, a substituted or unsubstituted C3 to C10 cycloalkenyl group, a substituted or unsubstituted C2 to C10 alkynyl group, a substituted or unsubstituted C3 to C10 cycloalkynyl group, or a substituted or unsubstituted C6 to C20 aryl group; and
if (e.g., when) X¹ and X² are concurrently (e.g., simultaneously) —O-L¹-R³, R³ may each independently be present, or two R³s may be linked to form a substituted or unsubstituted monocyclic or polycyclic aliphatic heterocycle, or a substituted or unsubstituted monocyclic or polycyclic aromatic heterocycle.

A fluorophosphite-based compound such as the additive may stabilize the lithium salt including the first lithium salt in the electrolyte solution. Through this, it may suppress or reduce decomposition of the electrolyte solution at high temperature, suppress or reduce generation of gas inside the battery, and concurrently (e.g., simultaneously) improve safety and cycle-life characteristics of the rechargeable lithium battery.

However, if (e.g., when) an electrolyte solution in which a lithium salt including about 10 to about 50 wt % of the first lithium salt and the additive are combined is utilized, and the relatively high-nickel-based positive electrode active material is applied, safety of the rechargeable lithium battery at room temperature and/or high temperature may be below a target level.

In some embodiments, if (e.g., when) an electrolyte solution in which a lithium salt including about 10 to about 50 wt % of the first lithium salt and the additive are combined is utilized, even if the relatively high-nickel-based positive electrode active material is applied, safety of the rechargeable lithium battery may be improved without deterioration in performance under any condition of room temperature and/or high temperature.

In one or more embodiments, if (e.g., when) the electrolyte solution in which a lithium salt including about 10 to about 50 wt % of the first lithium salt and the additive are combined, even if the relatively high-nickel-based positive electrode active material is applied, safety of the rechargeable lithium battery may be improved without deterioration in performance under any condition of room temperature and/or high temperature.

Hereinafter, a rechargeable lithium battery of one or more embodiments will be described in more detail.

### Lithium Salt

In one or more embodiments, R¹ and R² in Chemical Formula 1 may each independently be a fluoro group or a C1 to C4 alkyl group substituted with at least two fluoro groups.

In one or more embodiments, R¹ and R² in Chemical Formula 1 may each independently be a fluoro group or a C1 to C4 alkyl group substituted with at least three fluoro groups.

In some embodiments, R¹ and R² in Chemical Formula 1 may each independently be a fluoro group or a C1 to C3 alkyl group substituted with at least three fluoro groups.

In some embodiments, R¹ and R² in Chemical Formula 1 may each independently be a fluoro group or a C1 to C2 alkyl group substituted with at least three fluoro groups.

In some embodiments, R¹ and R² in Chemical Formula 1 may be the same.

In one or more embodiments, representative examples of the compound (first lithium salt) represented by Chemical Formula 1 may be as follows:

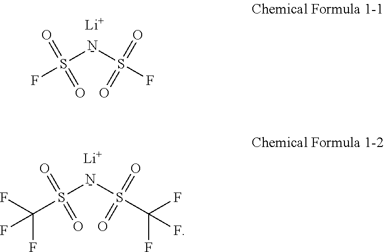 [SMILES: [Li+] ; O=S(=O)(F)[N-]S(=O)(=O)F ; [Li+] ; O=S(=O)([N-]S(=O)(=O)C(F)(F)F)C(F)(F)F]

In addition to the compound represented by Chemical Formula 1 (first lithium salt), in one or more embodiments, the lithium salt may further include one or two or more lithium salts selected from LiPF₆, LiBF₄, lithium difluoro(oxalate)borate (LiDFOB), LiPO₂F₂, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiN(CₚF₂ₚ₊₁SO₂)(C_{q}F_{2q+1}SO₂) wherein p and q are integers from 1 to 20, LiCl, LiI, and LiB(C₂O₄)₂ (lithium bis(oxalato) borate: LiBOB) (hereinafter referred to as ‘second lithium salt’ in some embodiments). The second lithium salt is dissolved in the non-aqueous organic solvent and serves as a source of lithium ions in the battery to enable basic operation of the rechargeable lithium battery and promotes movement of lithium ions between the positive electrode and the negative electrode.

In one or more embodiments, the lithium salt may include the compound represented by Chemical Formula 1 and LiPF₆. The compound represented by Chemical Formula 1 (first lithium salt) may be included in an amount of greater than or equal to about 10 wt %, greater than or equal to about 20 wt %, or greater than or equal to about 30 wt %, and less than or equal to about 50 wt %, or less than or equal to about 40 wt % based on a total amount of the lithium salt, and the LiPF₆ (second lithium salt) may be included in a balance amount. Herein, the total amount of the lithium salt may correspond to a molar concentration of about 0.1 M to about 2.0 M in the electrolyte solution.

### Additive

In one or more embodiments, one of X¹ and X² in Chemical Formula 2 may be a fluoro group, and the other may be —O-L²-R⁴; L² may be a single bond or a substituted or unsubstituted C1 to C10 alkylene group; and R⁴ may be a cyano group (—CN) or a difluorophosphite group (—OPF₂).

In some embodiments, Chemical Formula 2 may be Chemical Formula 2-1.

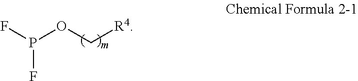

In Chemical Formula 2-1, m may be an integer of 1 to 5; R⁴ may be a cyano group (—CN) or a difluorophosphite group (—OPF₂).

In one or more embodiments, in Chemical Formula 2, X¹ may be —O-L³-R⁵ and X² may be —O-L⁴-R⁶; wherein L³ and L⁴ may each independently be a single bond or a substituted or unsubstituted C1 to C10 alkylene group; R⁵ and R⁶ may each independently be a substituted or unsubstituted C1 to C10 alkyl group, and/or R⁵ and R⁶ may be linked to each other to form a substituted or unsubstituted monocyclic or polycyclic aliphatic heterocycle.

In one or more embodiments, Chemical Formula 2 may be Chemical Formula 2-2.

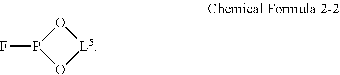

In Chemical Formula 2-2, L⁵ may be a substituted or unsubstituted C2 to C5 alkylene group.

In some embodiments, Chemical Formula 2-2 may be Chemical Formula 2-2a or Formula 2-2b.

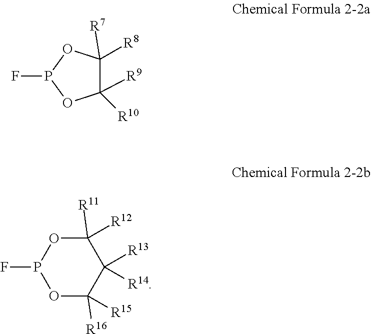

In Chemical Formulas 2-2a and 2-2b, R⁷ to R¹⁶ may each independently be hydrogen, a halogen, or a substituted or unsubstituted C1 to C5 alkyl group.

In one or more embodiments, representative examples of the compound (additive) represented by Chemical Formula 2 may be as follows:

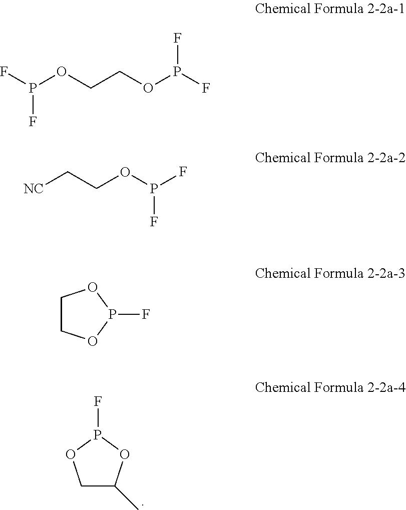

The additive may be included in an amount of greater than or equal to about 0.05 wt %, greater than or equal to about 0.1 wt %, greater than or equal to about 0.2 wt %, greater than or equal to about 0.3 wt %, greater than or equal to about 0.4 wt %, or greater than or equal to about 0.05 wt %; and less than or equal to about 5.0 wt %, less than or equal to about 4.0 wt %, less than or equal to about 3.0 wt %, less than or equal to about 2.0 wt %, or less than or equal to about 1.0 wt %, based on a total weight of the electrolyte solution.

For example, the rechargeable lithium battery of one or more embodiments may include an electrolyte solution including a non-aqueous organic solvent; a lithium salt including lithium bis(fluorosulfonyl)imide or cesium bis(trifluoromethanesulfonyl)imide (first lithium salt) and LiPF₆ (second lithium salt) in a balance amount; and at least one (additive) of the compounds listed above (e.g., compounds (additives) represented by Chemical Formulae 2-2a-1 to 2-2a-4). The concentration or content (e.g., amount) of each compound in the electrolyte solution may be as described above.

If (e.g., when) the content (e.g., amount) of the composition and the content (e.g., amount) of each component in the composition are within the above ranges, even if the energy density of the rechargeable lithium battery is increased, safety of the rechargeable lithium battery may be improved without deterioration in performance at room temperature and/or high temperature.

### Non-aqueous Organic Solvent

The non-aqueous organic solvent serves as a medium for transmitting ions taking part in the electrochemical reaction of a battery.

The non-aqueous organic solvent may include a carbonate-based, ester-based, ether-based, ketone-based, alcohol-based, or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), butylene carbonate (BC), and/or the like. The ester-based solvent may include methyl acetate, ethyl acetate, n-propyl acetate, t-butyl acetate, methylpropionate, ethylpropionate, propylpropionate, decanolide, mevalonolactone, caprolactone, and/or the like. The ether-based solvent may include dibutyl ether, tetraglyme, diglyme, dimethoxyethane, 2-methyltetrahydrofuran, tetrahydrofuran, and/or the like. The ketone-based solvent may include cyclohexanone and/or the like. The alcohol-based solvent may include ethyl alcohol, isopropyl alcohol, and/or the like, and non-limiting examples of the aprotic solvent may include nitriles such as R¹⁵—CN (wherein R¹⁵ is a C2 to C20 linear, branched, or cyclic hydrocarbon group, may include a double bond, an aromatic ring, or an ether bond), amides such as dimethylformamide, dioxolanes such as 1,3-dioxolane, sulfolanes, and/or the like.

The non-aqueous organic solvent may be utilized alone or in a mixture. If (e.g., when) the organic solvent is utilized in a mixture, a mixing ratio may be controlled or selected in accordance with a desirable battery performance.

In some embodiments, the carbonate-based solvent may be prepared by mixing a cyclic carbonate and a linear (e.g., a chain) carbonate. The cyclic carbonate and chain carbonate are mixed together in a volume ratio of about 1:9 to about 9:1. If (e.g., when) the mixture is utilized as an electrolyte solution, it may have enhanced performance.

In one or more embodiments of the present disclosure, the non-aqueous organic solvent may include the cyclic carbonate and the chain carbonate in a volume ratio of about 2:8 to about 5:5. In some embodiments, the cyclic carbonate and the chain carbonate may be included in a volume ratio of about 2:8 to about 4:6.

In some embodiments, the cyclic carbonate and the chain carbonate may be included in a volume ratio of about 2:8 to about 3:7.

In one or more embodiments, the non-aqueous organic solvent may further include an aromatic hydrocarbon-based solvent as well as the carbonate-based solvent. The carbonate-based solvent and aromatic hydrocarbon-based solvent may be mixed together in a volume ratio of about 1:1 to about 30:1.

The aromatic hydrocarbon-based solvent may be an aromatic hydrocarbon-based compound represented by Chemical Formula 4.

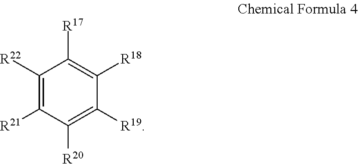

In Chemical Formula 4, R¹⁷ to R²² may each independently be the same or different and may each independently be selected from hydrogen, a halogen, a C1 to C10 alkyl group, a haloalkyl group, and a combination thereof.

Non-limiting examples of the aromatic hydrocarbon-based solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

### Positive Electrode Active Material and Positive Electrode Including the Same

The positive electrode may include a positive electrode current collector and a positive electrode active material layer on the positive electrode current collector, and the positive electrode active material layer may include a positive electrode active material.

The positive electrode active material may include lithiated intercalation compound(s) that reversibly intercalate and deintercalate lithium ions.

For example, at least one composite oxide of lithium and a metal of cobalt, manganese, nickel, or a combination thereof may be utilized.

In some embodiments, the composite oxide having a coating layer on the surface thereof may be utilized, or a mixture of the composite oxide and the composite oxide having a coating layer may be utilized. The coating layer may include one or more coating element compounds of an oxide or hydroxide of a coating element, oxyhydroxide of a coating element, oxycarbonate of a coating element, or hydroxycarbonate of a coating element. The compound for the coating layer may be either amorphous or crystalline. The coating element included in the coating layer may be Mg, Al, Co, K, Na, Ca, Si, Ti, V, Sn, Ge, Ga, B, As, Zr, or a mixture thereof. The coating process may include any coating process as long as it does not cause any side effects on the properties of the positive electrode active material (e.g., spray coating, dipping), which is well suitable to persons having ordinary skill in the art, and thus a detailed description thereof is not provided for conciseness.

In one or more embodiments, the positive electrode active material may be, for example, at least one of lithium composite oxides represented by Chemical Formula 3:

LiₐNiₓM¹_{y}M²_{z}O_{2-b}X_{b}, Chemical Formula 3
wherein, in Chemical Formula 3,
0.9≤a<1.2, 0.8<x≤1, 0≤y≤0.2, 0<z≤0.2, x+y+z=1, and 0≤b≤0.1;

M¹ and M² may each independently be one or more elements selected from Mn, Al, B, Ba, Ca, Ce, Co, Cr, Cu, Fe, Mg, Mn, Mo, Nb, Si, Sr, Ti, V, W, and Zr; and X may be one or more elements selected from F, P, and S.

In one or more embodiments, the positive electrode active material may include a composite oxide represented by Chemical Formula 3-1, a composite oxide represented by Chemical Formula 3-2, or a combination thereof:

Liₐ₁Niₓ₁Mn_{y1}M²_{z1}O_{2-b1}X_{b1} Chemical Formula 3-1

Liₐ₂Niₓ₂Mn_{y2}M²_{z2}O_{2-b2}X_{b2} Chemical Formula 3-2
wherein, in Chemical Formulas 3-1 and 3-2,
0.9≤a1<1.2, 0.8<x1≤1, 0≤y1≤0.2, 0<z1≤0.2, x1+y1+z1=1, and 0≤b1≤0.1;
0.9≤a2<1.2, 0.8<x2≤1, 0≤y2≤0.2, 0<z2≤0.2, x2+y2+z2=1, and 0≤b2≤0.1;
M² may be one or more elements selected from B, Ba, Ca, Ce, Co, Cr, Cu, Fe, Mg, Mn, Mo, Nb, Si, Sr, Ti, V, W, and Zr; and
X may be one or more elements selected from F, P, and S.

A content (e.g., amount) of the positive electrode active material may be about 90 wt % to about 98 wt % based on a total weight of the positive electrode active material layer.

In one or more embodiments of the present disclosure, the positive electrode active material layer may optionally include a conductive material and a binder. Herein, a content (e.g., amount) of the binder may be about 1 wt % to about 5 wt % based on a total weight of the positive electrode active material layer.

Each content (e.g., amount) of the conductive material and the binder may be about 1 wt % to about 5 wt %, respectively, based on a total weight of the positive electrode active material layer.

The conductive material may be utilized to impart conductivity to the positive electrode, and any electrically conductive material may be utilized as a conductive material unless it causes a chemical change in the battery. Non-limiting examples of the conductive material may include carbon-based materials such as natural graphite, artificial graphite, carbon black, acetylene black, ketjen black, carbon fiber, and/or the like; metal-based materials of metal powders or metal fibers including copper, nickel, aluminum, silver, and/or the like; conductive polymers such as polyphenylene derivatives; or mixtures thereof.

The binder improves binding properties of positive electrode active material particles with one another and with the positive electrode current collector, and non-limiting examples thereof may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and/or the like, but embodiments of the present disclosure are not limited thereto.

In some embodiments, aluminum (Al) may be utilized as the positive electrode current collector, but embodiments of the present disclosure are not limited thereto.

### Negative Electrode

The negative electrode may include a negative electrode current collector and a negative electrode active material layer including the negative electrode active material on the negative electrode current collector.

The negative electrode active material may be a material that reversibly intercalates/deintercalates lithium ions, a lithium metal, a lithium metal alloy, a material capable of doping and dedoping lithium, and/or a transition metal oxide.

The material that reversibly intercalates/deintercalates lithium ions may include carbon materials. The carbon material may be any generally-utilized carbon-based negative electrode active material in a rechargeable lithium battery. Non-limiting examples of the carbon material may include crystalline carbon, amorphous carbon, and/or a combination thereof. The crystalline carbon may be non-shaped (irregularly shaped), or sheet, flake, spherical, or fiber shaped natural graphite or artificial graphite. The amorphous carbon may be a soft carbon, a hard carbon, a mesophase pitch carbonized product, fired coke, and/or the like.

The lithium metal alloy may include lithium and a metal selected from sodium (Na), potassium (K), rubidium (Rb), cesium (Cs), francium (Fr), beryllium (Be), magnesium (Mg), calcium (Ca), strontium (Sr), silicon (Si), antimony (Sb), lead (Pb), indium (In), zinc (Zn), barium (Ba), radium (Ra), germanium (Ge), aluminum (Al), and tin (Sn).

The material capable of doping and dedoping lithium may include Si, SiOₓ (0<x<2), a Si-Q alloy (wherein Q is selected from an alkali metal, an alkaline-earth metal, a Group 13 element, a Group 14 element, a Group 15 element, a Group 16 element, a transition metal, a rare earth element, or a combination thereof, and not Si), Sn, SnO₂, a Sn—R alloy (wherein R is an alkali metal, an alkaline-earth metal, a Group 13 element, a Group 14 element, a Group 15 element, a Group 16 element, a transition element, a rare earth element, or a combination thereof, and not Sn), and/or the like. At least one of these materials may be mixed with SiO₂.

The elements Q and R may be selected from Mg, Ca, Sr, Ba, Ra, Sc, Y, Ti, Zr, hafnium (Hf), rutherfordium (Rf), V, Nb, tantalum (Ta), dubnium (Db), Cr, Mo, W, seaborgium (Sg), technetium (Tc), rhenium (Re), bohrium (Bh), Fe, Pb, ruthenium (Ru), osmium (Os), hassium (Hs), rhodium (Rh), iridium (Ir), palladium (Pd), platinum (Pt), Cu, silver (Ag), gold (Au), Zn, cadmium (Cd), B, Al, gallium (Ga), Sn, In, thallium (TI), Ge, P, arsenic (As), Sb, bismuth (Bi), S, Se, tellurium (Te), polonium (Po), and a combination thereof.

The transition metal oxide may be a vanadium oxide, a lithium vanadium oxide, and/or the like.

In one or more embodiments, the negative electrode active material may include at least one of graphite or a Si composite (e.g., in a form of particles).

The Si composite may include a core including Si particles and amorphous carbon, for example, the Si particles may include at least one selected from among Si composite, SiOₓ (0<x≤2), and an Si alloy.

For example, in some embodiments, the Si—C composite (e.g., in a form of particles) may include a core including Si particles and amorphous carbon.

A central portion of the core of the Si—C composite may include pores, and a radius of the central portion may correspond to about 30% to about 50% of a radius of the Si—C composite (e.g., Si—C composite particle).

The Si particles may have an average particle diameter of about 10 nm to about 200 nm.

As utilized herein, the average particle diameter may be a particle size (D50) at a volume ratio of 50% in a cumulative size-distribution curve.

If (e.g., when) the average particle diameter of the Si particle is within the above range, volume expansion occurring during charging and discharging may be suppressed or reduced, and a disconnection of a conductive path due to particle crushing during charging and discharging may be prevented or reduced.

The Si particle may be included in an amount of about 1 wt % to about 60 wt %, for example, about 3 wt % to about 60 wt %, based on a total weight of the Si—C composite.

The central portion may not include (e.g., may exclude) amorphous carbon, and the amorphous carbon may be present only on the surface portion of the negative electrode active material (e.g., on the surface portion of the Si—C composite particle).

Herein, the surface portion indicates a region from the central portion of the negative electrode active material particle (e.g., the Si—C composite particle) to the outermost surface of the negative electrode active material particle (e.g., the Si—C composite particle).

In some embodiments, the Si particles are substantially uniformly included over the negative electrode active material, for example, present at a substantially uniform concentration in the central portion and the surface portion thereof.

The amorphous carbon may be soft carbon, hard carbon, mesophase pitch carbonized product, calcined coke, or a combination thereof.

In one or more embodiments, the negative electrode active material may further include crystalline carbon (e.g., in a form of particles).

If (e.g., when) the negative electrode active material includes a Si—C composite and crystalline carbon together, the Si—C composite and crystalline carbon may be included in the form of a mixture. In some embodiments, the Si—C composite and crystalline carbon may be included in a weight ratio of about 1:99 to about 50:50. In some embodiments, the Si—C composite and crystalline carbon may be included in a weight ratio of 3:97 to 20:80 or 5:95 to 20:80.

In one or more embodiments, the crystalline carbon may be for example graphite, such as, natural graphite, artificial graphite, or a mixture thereof.

The crystalline carbon may have an average particle diameter of about 5 μm to about 30 μm.

An amorphous carbon precursor may include a coal-based pitch, mesophase pitch, petroleum-based pitch, coal-based oil, petroleum-based heavy oil, or a polymer resin such as a phenol resin, a furan resin, or a polyimide resin.

In the negative electrode active material layer, the negative electrode active material may be included in an amount of about 95 wt % to about 99 wt % based on a total weight of the negative electrode active material layer.

In one or more embodiments, the negative electrode active material layer may include a binder, and optionally a conductive material. In the negative electrode active material layer, an amount of the binder may be about 1 wt % to about 5 wt % based on a total weight of the negative electrode active material layer. If (e.g., when) the negative electrode active material layer further includes the conductive material, the negative electrode active material layer may include about 90 wt % to about 98 wt % of the negative electrode active material, about 1 wt % to about 5 wt % of the binder, and about 1 wt % to about 5 wt % of the conductive material.

The binder improves binding properties of negative electrode active material particles with one another and with the negative electrode current collector. The binder may be a non-water-soluble binder, a water-soluble binder, or a combination thereof.

The non-water-soluble binder may be polyvinylchloride, carboxylated polyvinylchloride, polyvinylfluoride, polyurethane, polytetrafluoroethylene, polyvinylidene fluoride, polyethylene, polypropylene, polyamideimide, polyimide, or a combination thereof.

The water-soluble binder may be a rubber-based binder or a polymer resin binder. The rubber-based binder may be selected from a styrene-butadiene rubber, an acrylated styrene-butadiene rubber (SBR), an acrylonitrile-butadiene rubber, an acrylic rubber, a butyl rubber, a fluorine rubber, and a combination thereof. The polymer resin binder may be selected from polytetrafluoroethylene, ethylenepropylene copolymer, polyethyleneoxide, polyvinylpyrrolidone, polyepichlorohydrin, polyphosphazene, polyacrylonitrile, polystyrene, an ethylene propylenediene copolymer, polyvinylpyridine, chlorosulfonated polyethylene, latex, a polyester resin, an acrylic resin, a phenolic resin, an epoxy resin, polyvinylalcohol, and a combination thereof.

If (e.g., when) the water-soluble binder is utilized as the binder for the negative electrode, a cellulose-based compound may be further utilized to provide viscosity as a thickener. The cellulose-based compound may include one or more of carboxylmethyl cellulose, hydroxypropylmethyl cellulose, methyl cellulose, or alkali metal salts thereof. The alkali metal may be Na, K, or Li. Such a thickener may be included in an amount of about 0.1 to about 3 parts by weight based on 100 parts by weight of the negative electrode active material.

The conductive material may be included to provide electrode conductivity and any electrically conductive material may be utilized as a conductive material unless it causes a chemical change. Non-limiting examples thereof may be carbon-based materials such as natural graphite, artificial graphite, carbon black, acetylene black, ketjen black, carbon fiber and/or the like; metal-based materials such as metal powders or metal fibers and/or the like of copper, nickel, aluminum, silver, and/or the like; conductive polymers such as polyphenylene derivatives and/or the like, or mixtures thereof.

The negative electrode current collector may be selected from a copper foil, a nickel foil, a stainless steel foil, a titanium foil, a nickel foam, a copper foam, a polymer substrate coated with a conductive metal, and a combination thereof.

### Separator

In one or more embodiments, the rechargeable lithium battery may further include a separator between the negative electrode and the positive electrode, depending on a type or kind of the rechargeable lithium battery. The separator may be porous substrates. In some embodiments, the separator may be a composite porous substrate.

The porous substrate may be a substrate including pores, and lithium ions may move through the pores. The porous substrate may be, for example, polyethylene, polypropylene, polyvinylidene fluoride, or multi-layers thereof such as a polyethylene/polypropylene double-layered separator, a polyethylene/polypropylene/polyethylene triple-layered separator, or a polypropylene/polyethylene/polypropylene triple-layered separator.

The composite porous substrate may have a form including a porous substrate and a functional layer on the porous substrate. The functional layer may be, for example, at least one selected from a heat-resistant layer and an adhesive layer from the viewpoint of enabling additional function. For example, in some embodiments, the heat-resistant layer may include a heat-resistant resin and optionally a filler.

In some embodiments, the adhesive layer may include an adhesive resin and optionally a filler.

The filler may be an organic filler and/or an inorganic filler.

Hereinafter, examples of the present disclosure and comparative examples are described in more detail. These examples, however, are not in any sense to be interpreted as limiting the scope of the present disclosure.

### Manufacture of Rechargeable Lithium Battery Cell

### Example 1-1

LiNi_{0.88}Co_{0.105}Al_{0.015}O₂ as a positive electrode active material, polyvinylidene fluoride as a binder, and ketjen black as a conductive material were mixed respectively in a weight ratio of 97:2:1, and then, dispersed in N-methyl pyrrolidone to prepare positive electrode active material slurry.

The positive electrode active material slurry was coated on a 14 μm-thick Al foil, dried at 110° C., and pressed to manufacture a positive electrode.

A mixture of artificial graphite and Si—C composite in a weight ratio of 93:7 was prepared as a negative electrode active material, and the negative electrode active material, a styrene-butadiene rubber as a binder, and carboxylmethyl cellulose as a thickener in a weight ratio of 97:1:2 were dispersed in distilled water to prepare negative electrode active material slurry.

The Si—C composite included a core including artificial graphite and silicon particles and coal pitch coated on the surface of the core.

The negative electrode active material slurry was coated on a 10 μm-thick Cu foil, dried at 100° C., and pressed to manufacture a negative electrode.

The manufactured positive and negative electrodes and a polyethylene separator having a thickness of 25 μm were assembled to manufacture an electrode assembly, and the electrolyte solution was injected to prepare a rechargeable lithium battery cell.

A composition of the electrolyte solution is as follows.

### Composition of Electrolyte Solution

### 1. Non-Aqueous Organic Solvent

A mixture in which ethylene carbonate, ethylmethyl carbonate, and dimethyl carbonate were mixed in a volume ratio of ethylene carbonate:ethylmethyl carbonate:dimethyl carbonate (EC:EMC:DMC)=20:10:70.

### 2. Lithium Salt

A mixture in which 10 wt % of a first lithium salt (LiFSI, Chemical Formula 1-1) and 90 wt % of a second lithium salt (LiPF₆) were mixed and a total amount of lithium salts (first lithium salt and second lithium salt) in the electrolyte solution corresponds to 1.5 M.

### 3. Additive

An additive (Chemical Formula 2-2a-4) was included in 1 wt % based on a total weight of the electrolyte solution (first lithium salt+second lithium salt+non-aqueous organic solvent+additive).

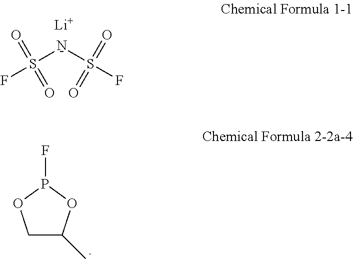

### Example 1-2

A rechargeable lithium battery cell was manufactured in substantially the same manner as in Example 1-1 except that a mixture of 35 wt % of the first lithium salt (LIFSI, Chemical Formula 1-1) and 65 wt % of the second lithium salt (LiPF₆) was utilized as the lithium salts.

### Example 1-3

A rechargeable lithium battery cell was manufactured in substantially the same manner as in Example 1-1 except that a mixture of 50 wt % of the first lithium salt (LIFSI, Chemical Formula 1-1) and 50 wt % of the second lithium salt (LiPF₆) was utilized as the lithium salts.

### Comparative Example 1-1

A rechargeable lithium battery cell was manufactured in substantially the same manner as in Example 1-1 except that the first lithium salt (LIFSI, Chemical Formula 1-1) was not utilized, but the second lithium salt (LiPF₆) alone was utilized as the lithium salts.

### Comparative Example 1-2

A rechargeable lithium battery cell was manufactured in substantially the same manner as in Example 1-1 except that a mixture of 80 wt % of the first lithium salt (LIFSI, Chemical Formula 1-1) and 20 wt % of the second lithium salt (LiPF₆) was utilized as the lithium salts.

### Examples 2-1 to 2-3

Each rechargeable lithium battery cell was manufactured in substantially the same manner as in Examples 1-1 to 1-3, respectively, except that LiNi_{0.91} Co_{0.075}Al_{0.015}O₂ was utilized as the positive electrode active material.

### Comparative Examples 2-1 and 2-2

Each rechargeable lithium battery cell was manufactured in substantially the same manner as in Comparative Example 1-1 and 1-2, respectively, except that LiNi_{0.91}Co_{0.075}Al_{0.015}O₂ was utilized as the positive electrode active material.

### Examples 3-1 to 3-3

Each rechargeable lithium battery cell was manufactured in substantially the same manner as in Examples 1-1 to 1-3, respectively, except that LiNi_{0.94}Co_{0.045}Al_{0.015}O₂ was utilized as the positive electrode active material.

### Comparative Examples 3-1 and 3-2

Each rechargeable lithium battery cell was manufactured in substantially the same manner as in Comparative Examples 1-1 and 1-2, respectively, except that LiNi_{0.94}Co_{0.045}Al_{0.015}O₂ was utilized as the positive electrode active material.

### Comparative Examples 4-1 to 4-3

Each rechargeable lithium battery cell was manufactured in substantially the same manner as in Examples 1-1 to 1-3, respectively, except that LiNi_{0.80}Co_{0.185}Al_{0.015}O₂ was utilized as the positive electrode active material.

### Comparative Examples 5-1 to 5-3

Each rechargeable lithium battery cell was manufactured in substantially the same manner as in Examples 1-1 to 1-3, respectively, except that LiNi_{0.60}Co_{0.2}Mn_{0.2}O₂ was utilized as the positive electrode active material.

### Comparative Examples 6-1 to 6-3

Each rechargeable lithium battery cell was manufactured in substantially the same manner as in Examples 1-1 to 1-3, respectively, except that LiNi_{0.50}Co_{0.2}Mn_{0.3}O₂ was utilized as the positive electrode active material.

### Comparative Examples 7-1 to 7-3

Each rechargeable lithium battery cell was manufactured in substantially the same manner as in Examples 1-1 to 1-3, respectively, except that LiNi_{0.30}Co_{0.35}Mn_{0.35}O₂ was utilized as the positive electrode active material.

The main components of rechargeable lithium battery cells according to the Examples and the Comparative Examples were shown in Tables 1 and 2.

TABLE 1

| | Positive electrode | | |
|---|---|---|---|
| | active material | | |
| | Nickel content | | |
| | (e.g., amount) | Electrolyte solution | |
| | [mol %] in the total | First lithium salt:Second | Content of additive in |
| | amount of | lithium salt | electrolyte solution |
| | (transition) metals | (weight ratio) | [wt %] |
| Comp. Ex. 1-1 | 88 | Second lithium salt | 1.0 |
| | | alone | |
| Ex. 1-1 | 88 | 10:90 | 1.0 |
| Ex. 1-2 | 88 | 35:65 | 1.0 |
| Ex. 1-3 | 88 | 50:50 | 1.0 |
| Comp. Ex. 1-2 | 88 | 80:20 | 1.0 |
| Comp. Ex. 2-1 | 91 | Second lithium salt | 1.0 |
| | | alone | |
| Ex. 2-1 | 91 | 10:90 | 1.0 |
| Ex. 2-2 | 91 | 35:65 | 1.0 |
| Ex. 2-3 | 91 | 50:50 | 1.0 |
| Comp. Ex. 2-2 | 91 | 80:20 | 1.0 |
| Comp. Ex. 3-1 | 94 | Second lithium salt | 1.0 |
| | | alone | |
| Ex. 3-1 | 94 | 10:90 | 1.0 |
| Ex. 3-2 | 94 | 35:65 | 1.0 |
| Ex. 3-3 | 94 | 50:50 | 1.0 |
| Comp. Ex. 3-2 | 94 | 80:20 | 1.0 |

TABLE 2

| | Positive electrode | | |
|---|---|---|---|
| | active material | | |
| | Nickel content (e.g., | Electrolyte solution | |
| | amount) [mol %] in | First lithium salt:Second | Content of additive |
| | the total amount of | lithium salt | in electrolyte |
| | (transition) metals | (weight ratio) | solution [wt %] |
| Comp. Ex. 4-1 | 80 | 10:90 | 1.0 |
| Comp. Ex. 4-2 | 80 | 35:65 | 1.0 |
| Comp. Ex. 4-3 | 80 | 50:50 | 1.0 |
| Comp. Ex. 5-1 | 60 | 10:90 | 1.0 |
| Comp. Ex. 5-2 | 60 | 35:65 | 1.0 |
| Comp. Ex. 5-3 | 60 | 50:50 | 1.0 |
| Comp. Ex. 6-1 | 50 | 10:90 | 1.0 |
| Comp. Ex. 6-2 | 50 | 35:65 | 1.0 |
| Comp. Ex. 6-3 | 50 | 50:50 | 1.0 |
| Comp. Ex. 7-1 | 30 | 10:90 | 1.0 |
| Comp. Ex. 7-2 | 30 | 35:65 | 1.0 |
| Comp. Ex. 7-3 | 30 | 50:50 | 1.0 |

Herein, in the positive electrode active material compositions of Tables 1 and 2, a unit of “mol %” of the nickel content (e.g., amount) was based on 100 mol % of a total amount (e.g., total mole amount) of metals excluding lithium in each positive electrode active material.

In addition, in the electrolyte solution compositions of Tables 1 and 2, the weight ratio of the first lithium salt:the second lithium salt was a ratio of contents (parts by weight) of each lithium salt.

In addition, in the electrolyte solution compositions of Tables 1 and 2, a unit “wt %” of the additive content (e.g., amount) was based on 100 wt % of a total content (e.g., amount) of each electrolyte solution (lithium salt+non-aqueous organic solvent+additive).

### Evaluation 1: Evaluation of Initial Resistance Characteristics

The rechargeable lithium battery cells according to the Examples and the Comparative Examples were each charged at 4 A and 4.2 V, cut off at 100 mA, and paused for 30 minutes at room temperature (25° C.). Subsequently, the cells were each discharged at 10 A for 10 seconds, at 1 A for 10 seconds, and at 10 A for 4 seconds, respectively, and then, measured with respect to a current and a voltage at 18 seconds and 23 seconds, respectively, to calculate initial resistance (a resistance difference at 18 seconds and 23 seconds) according to ΔR=ΔV/ΔI, and the results are shown in Table 3.

### Evaluation 2: Evaluation of High-temperature Characteristics

High-temperature characteristics of each of the cells are evaluated under the following conditions, and the results are shown in Tables 3 and 4.
(1) High-temperature leaving characteristics: The rechargeable lithium battery cells of the Examples and the Comparative Examples were each allowed to stand in a 60° C. chamber for 30 days to measure direct current internal resistance (DC-IR).
(2) Storage characteristics at a high temperature: The rechargeable lithium battery cells of the Examples and the Comparative Examples were each allowed to stand at 60° C. for 30 days and then, measured with respect to direct current internal resistance (DC-IR).
(3) High-temperature cycle-life characteristics: The rechargeable lithium battery cells of the Examples and the Comparative Examples were each charged to 4.2 V under a condition of 1.0 C constant current/constant voltage, cut off at 0.33 C, and discharged to 3.0 V under a constant current condition of 1.0 C at 45° C., which was regarded as one charge and discharge cycle, and this charge and discharge cycle was repeated 200 times to measure a percentage (%) ratio of discharge capacity after the high-temperature cycles to discharge capacity before the high-temperature cycles.

TABLE 3

| | Manufacturing condition of | | | | | | |
|---|---|---|---|---|---|---|---|
| | rechargeable lithium battery cells | | | | | | |
| | Positive electrode | | | | | | |
| | active material | | | Evaluation results of rechargeable lithium battery cells | | | |
| | Nickel content | | | | High temperature | | |
| | (e.g., amount) | Electrolyte solution | | | | DCIR increase | DCIR increase |
| | [mol %] in | | Content of | | | rate during high- | rate after high |
| | the total | First lithium | additive in | Initial | DCIR (mOhm) | temperature | temperature |
| | amount of | salt:Second | electrolyte | Initial | after being | storage (%, | cycle-life |
| | (transition) | lithium salt | solution | DCIR | left at a high | 60° C. for 30 | (%, 45° C., |
| | metals | (weight ratio) | [wt %] | (mOhm) | temperature | days) | 200 cycles) |
| Comp. | 88 | Second | 1.0 | 30.8 | 33.1 | 7.50%, e.g., | 80% |
| Ex. 1-1 | | lithium salt | | | | ((33.1-30.8)/ | |
| | | alone | | | | 30.8) × 100 | |
| Ex. 1-1 | 88 | 10:90 | 1.0 | 30.6 | 32.5 | 6.20% | 78% |
| Ex. 1-2 | 88 | 35:65 | 1.0 | 30 | 31.6 | 5.30% | 76% |
| Ex. 1-3 | 88 | 50:50 | 1.0 | 29.5 | 30.8 | 4.40% | 71% |
| Comp. | 88 | 80:20 | 1.0 | 31 | 32.9 | 6.10% | 73% |
| Ex. 1-2 | | | | | | | |
| Comp. | 91 | Second | 1.0 | 30.3 | 32.1 | 5.90% | 70% |
| Ex. 2-1 | | lithium salt | | | | | |
| | | alone | | | | | |
| Ex. 2-1 | 91 | 10:90 | 1.0 | 29.8 | 30.8 | 3.40% | 68% |
| Ex. 2-2 | 91 | 35:65 | 1.0 | 29.5 | 30.1 | 2.00% | 60% |
| Ex. 2-3 | 91 | 50:50 | 1.0 | 29 | 29.5 | 1.70% | 58% |
| Comp. | 91 | 80:20 | 1.0 | 29.6 | 30.3 | 2.40% | 62% |
| Ex. 2-2 | | | | | | | |
| Comp. | 94 | Second | 1.0 | 29.2 | 31.6 | 8.20% | 73% |
| Ex. 3-1 | | lithium salt | | | | | |
| | | alone | | | | | |
| Ex. 3-1 | 94 | 10:90 | 1.0 | 28.9 | 30.9 | 6.90% | 67% |
| Ex. 3-2 | 94 | 35:65 | 1.0 | 28.7 | 30.4 | 5.90% | 66% |
| Ex. 3-3 | 94 | 50:50 | 1.0 | 28.1 | 29.5 | 5.00% | 64% |
| Comp. | 94 | 80:20 | 1.0 | 28.5 | 30.7 | 7.70% | 70% |
| Ex. 3-2 | | | | | | | |

TABLE 4

| | Manufacturing | | | | | | |
|---|---|---|---|---|---|---|---|
| | condition of | | | | | | |
| | rechargeable | | | | | | |
| | lithium battery | | | | | | |
| | cells | | | | | | |
| | Positive electrode | | | | | | |
| | active material | Evaluation results of rechargeable lithium battery cells | | | | | |
| | Nickel content | | | | High temperature | | |
| | (e.g., amount) | Electrolyte solution | | | | DCIR increase | DCIR increase |
| | [mol %] in | | Content of | | | rate during high- | rate after high |
| | the total | First lithium | additive in | Initial | DCIR (mOhm) | temperature | temperature |
| | amount of | salt:Second | electrolyte | Initial | after being | storage (%, | cycle-life |
| | (transition) | lithium salt | solution | DCIR | left at a high | 60° C. for 30 | (%, 45° C. |
| | metals | (weight ratio) | [wt %] | (mOhm) | temperature | days) | 200 cycles) |
| Comp. Ex. 4-1 | 80 | 10:90 | 1.0 | 35.5 | 40.4 | 13.8% | 83% |
| Comp. Ex. 4-2 | 80 | 35:65 | 1.0 | 35.4 | 40.5 | 14.4% | 84% |
| Comp. Ex. 4-3 | 80 | 50:50 | 1.0 | 36.2 | 43.6 | 20.4% | 87% |
| Comp. Ex. 5-1 | 60 | 10:90 | 1.0 | 40.9 | 45.9 | 12.20% | 86% |
| Comp. Ex. 5-2 | 60 | 35:65 | 1.0 | 39.7 | 44.9 | 13.10% | 88% |
| Comp. Ex. 5-3 | 60 | 50:50 | 1.0 | 40.2 | 53.3 | 32.60% | 92% |
| Comp. Ex. 6-1 | 50 | 10:90 | 1.0 | 45.3 | 52.3 | 15.50% | 89% |
| Comp. Ex. 6-2 | 50 | 35:65 | 1.0 | 44.9 | 59.6 | 32.70% | 95% |
| Comp. Ex. 6-3 | 50 | 50:50 | 1.0 | 51.5 | 63.3 | 22.90% | 92% |
| Comp. Ex. 7-1 | 30 | 10:90 | 1.0 | 53.2 | 60.2 | 13.20% | 94% |
| Comp. Ex. 7-2 | 30 | 35:65 | 1.0 | 54.2 | 65.5 | 20.80% | 96% |
| Comp. Ex. 7-3 | 30 | 50:50 | 1.0 | 56.6 | 69.9 | 23.50% | 102% |

Referring to Tables 3 and 4, when the positive electrode active materials with the same nickel content (e.g., amount) were applied, safety of the rechargeable lithium battery cells was improved by utilizing the electrolyte solutions with combinations of the first lithium salt and the additive.

However, when electrolyte solutions including combinations of lithium salts including less than 10 wt % or greater than 50 wt % of the first lithium salt and the additive were utilized, and the relatively high nickel-based positive electrode active material was applied, the safety of the rechargeable lithium battery cells may fall below the target level under room-temperature and/or high-temperature conditions.

In contrast, when electrolyte solutions including combinations of lithium salt including about 10 wt % to about 50 wt % of the first lithium salt and the additive were utilized, even though the relatively high nickel-based positive electrode active material was applied, the safety of rechargeable lithium battery cells may be improved without deteriorating performance under the high-temperature condition.

For example, in Examples 1-1 to 1-3 and Comparative Examples 1-1 and 1-2 in which the positive electrode active materials with the same nickel content (e.g., amount) were applied, Examples 1-1 to 1-3 utilizing the electrolyte solutions including combinations of lithium salts including about 10 wt % to about 50 wt % of the first lithium salt and the additive, compared with Comparative Examples 1-1 and 1-2 utilizing the electrolyte solutions including combinations of lithium salts including less than 10 wt % or greater than 50 wt % of the first lithium salt and the additive, exhibited improved safety of the rechargeable lithium battery cells without deteriorating performance under the high temperature conditions such as high temperature cycle-life, etc. when allowed to stand at the high temperature.

For another example, in the comparative examples, to which a positive electrode active material with less than 80 mol % of a nickel content (e.g., amount) was applied, even though an electrolyte solution including combinations of lithium salts including the first lithium salt within the wt % range (e.g., about 10 wt % to about 50 wt %) and the additive was utilized, the safety of rechargeable lithium battery cells fell below the target level without deteriorating performance under the high temperature conditions such as high-temperature cycle-life, etc., when allowed to stand at a high temperature.

In the present disclosure, it should be understood that terms such as “comprise(s),” “include(s),” or “have/has” are intended to designate the presence of an embodied feature, number, step, element, or a combination thereof, but it does not preclude the possibility of the presence or addition of one or more other features, number, step, element, or a combination thereof.

Herein, “or” is not to be construed as an exclusive meaning, for example, “A or B” is construed to include A, B, A+B, and/or the like. Further, as used herein, the term “and/or” includes any and all combinations of one or more of the associated listed items. The “/” utilized herein may be interpreted as “and” or as “or” depending on the situation. Expressions such as “at least one of,” “one of,” and “selected from,” when preceding a list of elements, modify the entire list of elements and do not modify the individual elements of the list. For example, “at least one of a, b, or c”, “at least one of a, b, and/or c”, “at least one selected from a, b, and c”, “at least one selected from among a to c”, etc. may indicate only a, only b, only c, both (e.g., simultaneously) a and b, both (e.g., simultaneously) a and c, both (e.g., simultaneously) b and c, all of a, b, and c, or variations thereof.

In the drawings, the thickness of layers, films, panels, regions, etc., are exaggerated for clarity and like reference numerals designate like elements throughout, and duplicative descriptions thereof may not be provided the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In the present disclosure, although the terms “first,” “second,” etc., may be utilized herein to describe one or more elements, components, regions, and/or layers, these elements, components, regions, and/or layers should not be limited by these terms. These terms are only utilized to distinguish one component from another component.

As utilized herein, the singular forms “a,” “an,” and “the” are intended to include the plural forms as well, unless the context clearly indicates otherwise. Further, the utilization of “may” when describing embodiments of the present disclosure refers to “one or more embodiments of the present disclosure”.

As utilized herein, the term “substantially,” “about,” and similar terms are utilized as terms of approximation and not as terms of degree, and are intended to account for the inherent deviations in measured or calculated values that would be recognized by those of ordinary skill in the art. “About” or “approximately,” as utilized herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

Also, any numerical range recited herein is intended to include all subranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

In the present disclosure, when particles are spherical, “size” or “diameter” indicates a particle diameter or an average particle diameter, and when the particles are non-spherical, the “size” or “diameter” indicates a major axis length or an average major axis length. That is, when particles are spherical, “diameter” indicates a particle diameter, and when the particles are non-spherical, the “diameter” indicates a major axis length. The size or diameter of the particles may be measured utilizing a scanning electron microscope or a particle size analyzer. As the particle size analyzer, for example, HORIBA, LA-950 laser particle size analyzer, may be utilized. When the size of the particles is measured utilizing a particle size analyzer, the average particle diameter (or size) is referred to as D50. D50 refers to the average diameter (or size) of particles whose cumulative volume corresponds to 50 vol % in the particle size distribution (e.g., cumulative distribution), and refers to the value of the particle size corresponding to 50% from the smallest particle when the total number of particles is 100% in the distribution curve accumulated in the order of the smallest particle size to the largest particle size.

While the present disclosure has been described in connection with what is presently considered to be practical example embodiments, it is to be understood that the present disclosure is not limited to the disclosed embodiments, but, on the contrary, is intended to cover one or more suitable modifications and equivalent arrangements included within the spirit and scope of the appended claims and equivalents thereof.

### REFERENCE NUMERALS

100: rechargeable lithium battery
112: negative electrode
113: separator
114: positive electrode
120: battery case
140: sealing member

What is claimed is:

1. A rechargeable lithium battery, comprising:
a positive electrode comprising a positive electrode active material;
a negative electrode comprising a negative electrode active material; and
an electrolyte solution comprising a non-aqueous organic solvent, a lithium salt, and an additive,
wherein the positive electrode active material comprises a composite oxide having a nickel amount of greater than about 80 mol % based on a total amount of metals except lithium in the composite oxide,
the lithium salt comprises a compound represented by Chemical Formula 1, and the compound represented by Chemical Formula 1 is in about 10 wt % to about 50 wt % based on a total amount of the lithium salt, and
the additive comprises a compound represented by Chemical Formula 2: 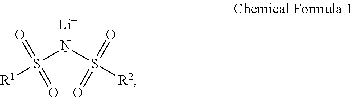
wherein, in Chemical Formula 1,
R¹ and R² are each independently a fluoro group or a C1 to C4 alkyl group substituted with at least one fluoro group; 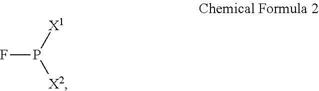
and
wherein, in Chemical Formula 2,
X¹ and X² are each a halogen, or —O-L¹-R³, provided that at least one of X¹ or X² is —O-L¹-R³;
L¹ is a single bond or a substituted or unsubstituted C1 to C10 alkylene group;
R³ is each independently a cyano group (—CN), a difluorophosphite group (—OPF₂), a substituted or unsubstituted C1 to C10 alkyl group, a substituted or unsubstituted C2 to C10 alkenyl group, a substituted or unsubstituted C3 to C10 cycloalkyl group, a substituted or unsubstituted C3 to C10 cycloalkenyl group, a substituted or unsubstituted C2 to C10 alkynyl group, a substituted or unsubstituted C3 to C10 cycloalkynyl group, or a substituted or unsubstituted C6 to C20 aryl group; and
when X¹ and X² are concurrently —O-L¹-R³, R³ is each independently present, or two R³s are linked to form a substituted or unsubstituted monocyclic or polycyclic aliphatic heterocycle, or a substituted or unsubstituted monocyclic or polycyclic aromatic heterocycle.

2. The rechargeable lithium battery as claimed in claim 1, wherein
in Chemical Formula 1,
R¹ and R² are each independently a fluoro group or a C1 to C4 alkyl group substituted with at least three fluoro groups.

3. The rechargeable lithium battery as claimed in claim 2, wherein
in Chemical Formula 1,
R¹ and R² are the same.

4. The rechargeable lithium battery as claimed in claim 3, wherein
Chemical Formula 1 is Chemical Formula 1-1 or Chemical Formula 1-2:

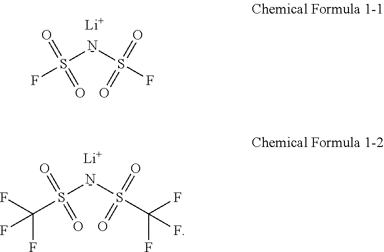 [SMILES: [Li+] ; O=S(=O)(F)[N-]S(=O)(=O)F ; [Li+] ; O=S(=O)([N-]S(=O)(=O)C(F)(F)F)C(F)(F)F]

5. The rechargeable lithium battery as claimed in claim 1, wherein
the lithium salt further comprises at least one selected from LiPF₆, LiBF₄, lithium difluoro(oxalate)borate, LiPO₂F₂, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiN(CₚF₂ₚ₊₁SO₂)(C_{q}F_{2q+1}SO₂), wherein p and q are integers from 1 to 20, LiCl, LiI, and LiB(C2O₄)₂.

6. The rechargeable lithium battery as claimed in claim 5, wherein
the lithium salt comprises the compound represented by Chemical Formula 1 and LiPF₆.

7. The rechargeable lithium battery as claimed in claim 6, wherein
based on a total amount of the lithium salt, the compound represented by Chemical Formula 1 is in an amount of about 10 wt % to about 50 wt %, and LiPF₆ is in a balance amount.

8. The rechargeable lithium battery as claimed in claim 7, wherein
a total amount of the lithium salt corresponds to a molar concentration of about 0.1 M to about 2.0 M in the electrolyte solution.

9. The rechargeable lithium battery as claimed in claim 1, wherein
in Chemical Formula 2,
one of X¹ and X² is a fluoro group, and the other is —O-L²-R⁴;
L² is a single bond or a substituted or unsubstituted C1 to C10 alkylene group; and
R⁴ is a cyano group (—CN) or a difluorophosphite group (—OPF₂).

10. The rechargeable lithium battery as claimed in claim 9, wherein
Chemical Formula 2 is Chemical Formula 2-1: 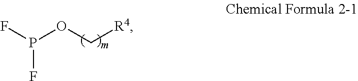
and
wherein, in Chemical Formula 2-1,
m is an integer from 1 to 5; and
R⁴ is a cyano group (—CN) or a difluorophosphite group (—OPF₂).

11. The rechargeable lithium battery as claimed in claim 1, wherein
in Chemical Formula 2,
X¹ is —O-L³-R⁵ and X² is —O-L⁴-R⁶;
L³ and L⁴ are each independently a single bond or a substituted or unsubstituted C1 to C10 alkylene group; and
R⁵ and R⁶ are each independently a substituted or unsubstituted C1 to C10 alkyl group, or R⁵ and R⁶ are linked to form a substituted or unsubstituted monocyclic or polycyclic aliphatic heterocycle.

12. The rechargeable lithium battery as claimed in claim 11, wherein
Chemical Formula 2 is Chemical Formula 2-2: 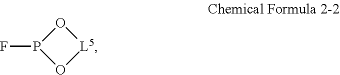
and
wherein, in Chemical Formula 2-2,
L⁵ is a substituted or unsubstituted C2 to C5 alkylene group.

13. The rechargeable lithium battery as claimed in claim 12, wherein
Chemical Formula 2-2 is Chemical Formula 2-2a or Chemical Formula 2-2b: 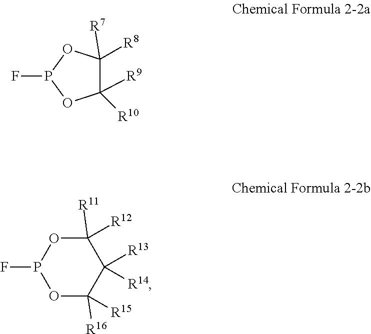
and
wherein, in Chemical Formulas 2-2a and 2-2b,
R⁷ to R¹⁶ are each independently hydrogen, a halogen, or a substituted or unsubstituted C1 to C5 alkyl group.

14. The rechargeable lithium battery as claimed in claim 1, wherein
the additive is any one selected from:

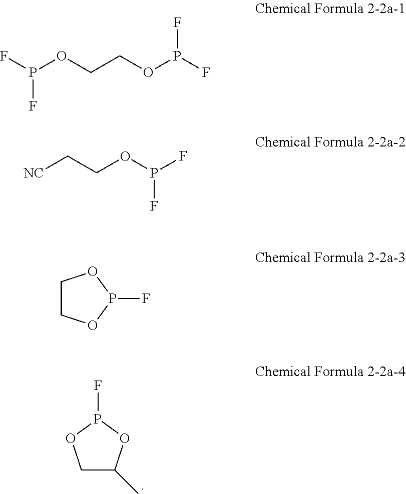

15. The rechargeable lithium battery as claimed in claim 1, wherein
the additive is in an amount of about 0.05 wt % to about 5.0 wt % based on a total weight of the electrolyte solution.

16. The rechargeable lithium battery as claimed in claim 1, wherein
the positive electrode active material comprises a composite oxide represented by Chemical Formula 3:
LiₐNiₓM¹_{y}M²_{z}O_{2-b}X_{b} Chemical Formula 3
wherein, in Chemical Formula 3,
0.9≤a<1.2, 0.8<x≤1, 0≤y≤0.2, 0<z≤0.2, x+y+z=1, and 0≤ b≤0.1;
M¹ and M² are each independently one or more elements selected from Mn, Al, B, Ba, Ca, Ce, Co, Cr, Cu, Fe, Mg, Mo, Nb, Si, Sr, Ti, V, W, and Zr; and
X is one or more elements selected from F, P, and S.

17. The rechargeable lithium battery as claimed in claim 16, wherein
the positive electrode active material comprises a composite oxide represented by Chemical Formula 3-1, a composite oxide represented by Chemical Formula 3-2, or a combination thereof:
Liₐ₁Niₓ₁Mn_{y1}M²_{z1}O_{2-b1}X_{b1} Chemical Formula 3-1
Liₐ₂Niₓ₂Mn_{y2}M²_{z2}O_{2-b2}X_{b2} Chemical Formula 3-2
wherein, in Chemical Formulas 3-1 and 3-2,
0.9≤a1<1.2, 0.8<x1≤1, 0≤y1≤0.2, 0<z1≤0.2, x1+y1+z1=1, and 0≤ b1≤0.1;
0.9≤a2<1.2, 0.8<x2≤1, 0≤y2≤0.2, 0<z2≤0.2, x2+y2+z2=1, and 0≤b2≤0.1;
M² is one or more elements selected from B, Ba, Ca, Ce, Co, Cr, Cu, Fe, Mg, Mn, Mo, Nb, Si, Sr, Ti, V, W, and Zr; and
X is one or more elements selected from F, P, and S.
